(19) United States
(12) Patent Application Publication
(10) Pub. No.: US 2024/0429643 A1
(43) Pub. Date: Dec. 26, 2024

(54) CONNECTOR

(71) Applicant: SUMITOMO WIRING SYSTEMS, LTD., Mie (JP)

(72) Inventor: Hiroaki TSUTSUMI, Mie (JP)

(21) Appl. No.: 18/743,342

(22) Filed: Jun. 14, 2024

(30) Foreign Application Priority Data
Jun. 22, 2023 (JP) 2023-102328

(51) Int. Cl. H01R 13/502; H01R 12/55; H01R 13/639; H01R 13/652

(52) U.S. Cl. CPC H01R 13/502; H01R 12/55; H01R 13/639; H01R 13/652

(57) ABSTRACT

An outer conductor 30 of a connector 10 includes a tubular body portion having open front and rear surfaces, a back plate portion 47 arranged displaceably with respect to a body portion 31 from an open state to a closed state, and side plate portions 51 projecting from left and right end parts of the back plate portion 47. The body portion 31 includes inner plate portions 39 arranged in the left and right end parts. The inner plate portions 39 are arranged to contact the inner surfaces of the side plate portions 51 in the closed state of the back plate portion 51. A housing 20 includes pressing portions 40 for pressing the side plate portions 51 against the inner plate portions 39.

### CROSS-REFERENCE TO RELATED APPLICATIONS

This application is based on and claims priority from Japanese Patent Application No. 2023-102328, filed on Jun. 22, 2023, with the Japan Patent Office, the disclosure of which is incorporated herein in its entirety by reference.

### TECHNICAL FIELD

The present disclosure relates to a connector.

### BACKGROUND

A connector disclosed in International Application Publication No. WO 2019/189629 is provided with a connector housing, an outer conductor terminal and an inner conductor terminal. The outer conductor terminal is accommodated into the connector housing. The outer conductor terminal includes a terminal body capable of surrounding the outer periphery of the inner conductor terminal and lock receiving portions formed on left and right end parts of the terminal body. Further, the outer conductor terminal includes a back plate portion for displacing from an open state to a closed state with respect to the terminal body and closing a back surface opening of the terminal body in the closed state, and side plate portions for covering the lock receiving portions from outer left and right sides in the closed state. The side plate portions are arranged in contact with the lock receiving portions. A connector provided with members equivalent to a connector housing, an outer conductor terminal and an inner conductor terminal is also disclosed in Japanese Patent Laid-open Publication Nos. H11-339870, 2021-158052, 2020-013748 and 2005-317267.

### SUMMARY

In the case of International Application Publication No. WO 2019/189629, if the side plate portions are displaced toward the outer left and right sides in directions separating from the lock receiving portions, a connected state of the side plate portions and the lock receiving portions cannot be maintained and it becomes difficult to stabilize the shielding performance of the outer conductor terminal. In contrast, even if techniques disclosed in Japanese Patent Laid-open Publication Nos. H11-339870, 2021-158052, 2020-013748 and 2005-317267 are applied to International Application Publication No. WO 2019/189629, there is a problem that it is difficult to sufficiently maintain the connected state of the side plate portions and the lock receiving portions.

The present disclosure provides a connector capable of stabilizing the shielding performance of an outer conductor.

The present disclosure is directed to a connector with an outer conductor, a housing for accommodating the outer conductor, and an inner conductor to be arranged inside the outer conductor, the outer conductor including a tubular body portion having open front and rear surfaces, a back plate portion arranged displaceably with respect to the body portion from an open state for opening an opening in the rear surface of the body portion to a closed state for closing the opening in the rear surface of the body portion and side plate portions projecting from left and right end parts of the back plate portion, the body portion including inner plate portions arranged in the left and right end parts, the inner plate portions being arranged to contact inner surfaces in a lateral direction of the side plate portions in the closed state of the back plate portion, and the housing including pressing portions for pressing the side plate portions against the inner plate portions.

The present disclosure can provide a connector capable of stabilizing the shielding performance of an outer conductor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a back view of a connector of one embodiment.

FIG. 2 is a side view in section of the connector of the embodiment.

FIG. 3 is a partial enlarged back view of the connector of the embodiment.

FIG. 4 is a back perspective view of a housing in the connector of the embodiment.

FIG. 5 is a partial enlarged section cut at a height position corresponding to pressing body portions of the connector of the embodiment.

FIG. 6 is a partial enlarged section cut at a height position corresponding to locking portions of the connector of the embodiment.

FIG. 7 is a side view of an outer conductor in a closed state of a back plate portion in the connector of the embodiment.

FIG. 8 is a side view of the outer conductor in an open state of a back plate portion in the connector of the embodiment.

FIG. 9 is a partial enlarged bottom view showing the arrangement of ground pins and the like in the connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

Hereinafter, embodiments of the present disclosure are listed and described. Note that features of [1] to [6] illustrated below may be combined in any arbitrary way without contradiction.

[1] The connector of the present disclosure is provided with an outer conductor, a housing for accommodating the outer conductor, and an inner conductor to be arranged inside the outer conductor, the outer conductor including a tubular body portion having open front and rear surfaces, a back plate portion arranged displaceably with respect to the body portion from an open state for opening an opening in the rear surface of the body portion to a closed state for closing the opening in the rear surface of the body portion and side plate portions projecting from left and right end parts of the back plate portion, the body portion including inner plate portions arranged in the left and right end parts, the inner plate portions being arranged to contact inner surfaces in a lateral direction of the side plate portions in the closed state of the back plate portion, and the housing including pressing portions for pressing the side plate portions against the inner plate portions. Since the side plate portions are pressed against the inner plate portions by the pressing portions of the housing, a connected state of the side plate portions and the inner plate portions can be maintained and the shielding performance of the outer conductor can be stabilized.

[2] Preferably, in the connector of [1] described above, the pressing portion includes a wall portion for covering an outer surface in the lateral direction of the side plate portion, and a pressing body portion for contacting the outer surface of the side plate portion by projecting from the wall portion. By adjusting the formation position, the formation range and the like of the pressing body portion on the wall portion, the connected state of the side plate portion and the inner plate portion can be more properly maintained.

[3] Preferably, in the connector of [2] described above, the side plate portion is formed with a base end portion, a locking portion and a tip portion successively arranged from the back plate portion side to a tip in a projecting direction, and the pressing body portion is configured to contact at least the outer surface of the tip portion. If the side plate portion is opened laterally outward with a part coupled to the back plate portion on the side of the base end portion as a fulcrum, the tip portion is displaced more laterally outward than the base end portion. In contrast, the configuration of [3] described above can suppress a lateral outward displacement of the tip portion since the pressing body portion contacts the outer surface of the tip portion. As a result, the side plate portion can be effectively prevented from being opened laterally outward, and the connected state of the side plate portion and the inner plate portion can be more properly maintained.

[4] Preferably, in the connector of [3] described above, the pressing body portion is in the form of a rib extending in a front-rear direction across the locking portion and configured to contact the outer surface of the base end portion and the outer surface of the tip portion. Since lateral outward displacements of the tip portion and the base end portion can be suppressed, a state where the locking portion formed between the tip portion and the base end portion is locked to the inner plate portion can be stably maintained.

[5] Preferably, in the connector of any one of [1] to [4] described above, the body portion includes a tubular connecting portion to be arranged in front of the inner plate portions and a slit formed between the tubular connecting portion and the inner plate portion, and the side plate portion is arranged to be accommodated in a formation range in a front-rear direction of the inner plate portion. According to this configuration, since a state where the inner surface of the side plate portion is in contact with only the inner plate portion can be realized, the connected state of the side plate portion and the inner plate portion can be more properly maintained.

[6] Preferably, in the connector of any one of [1] to [5] described above, the side plate portion includes a side ground pin to be connected to a circuit board. According to this configuration, since a ground current can flow from the side plate portion to the circuit board, shielding performance can be improved as compared to the case where the side plate portion includes no side ground pin.

### DETAILS OF EMBODIMENT OF PRESENT DISCLOSURE

An embodiment of the present disclosure is described below with reference to the drawings. The present disclosure is not limited to these illustrations, but is represented by claims and intended to include all changes in the scope of claims and in the meaning and scope of equivalents.

### Embodiment

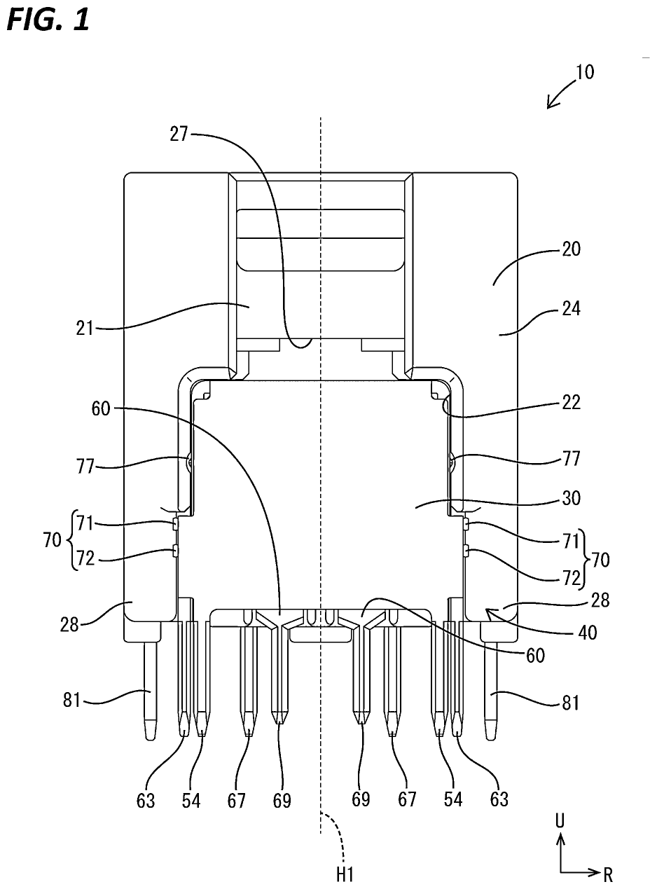

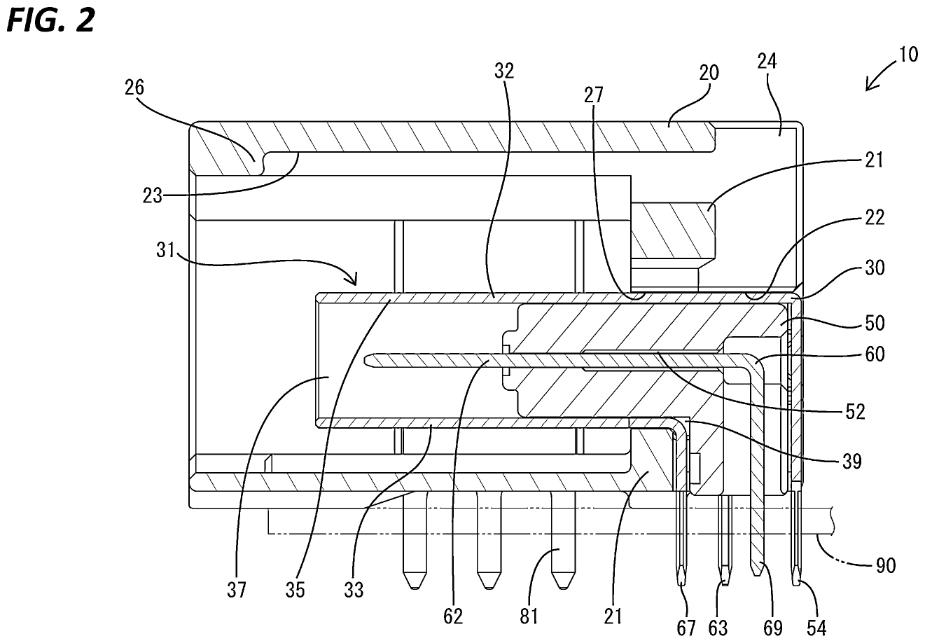

As shown in FIGS. 1 and 2, a connector 10 is provided with a housing 20, an outer conductor 30, a dielectric 50 and inner conductors 60. The housing 20 is connectable to an unillustrated mating housing. In this embodiment, a width direction of the connector 10 is referred to as a lateral direction, and a connection direction of the housing 20 and the mating housing is referred to as a front-rear direction. A height direction of the connector 10 is synonymous with a vertical direction. A “front side” is represented by “F” in FIGS. 2 and 4 to 9, an “upper side” is represented by “U” in FIGS. 1 to 4, 7 and 8, and a “right side” is represented by “R” in FIGS. 1, 3 to 6 and 9. Direction references are for convenience and do not necessarily coincide with those in a state where the connector 10 is installed in a vehicle or the like.

Further, in the following description, an “inner side” is a side facing a center of the connector 10, and an “inner surface” is a surface on the “inner side”. For example, an inner side in the lateral direction is a side facing a center in the lateral direction of the connector 10, and an inner surface in the lateral direction is a surface facing the center in the lateral direction of the connector 10. An “outer side” is a side separating from the center of the connector 10, and an “outer surface” is a surface on the “outer side”. For example, an outer side in the lateral direction is a side separating from the center in the lateral direction of the connector 10, and an outer surface in the lateral direction is a surface facing the side separating from the center in the lateral direction of the connector 10.

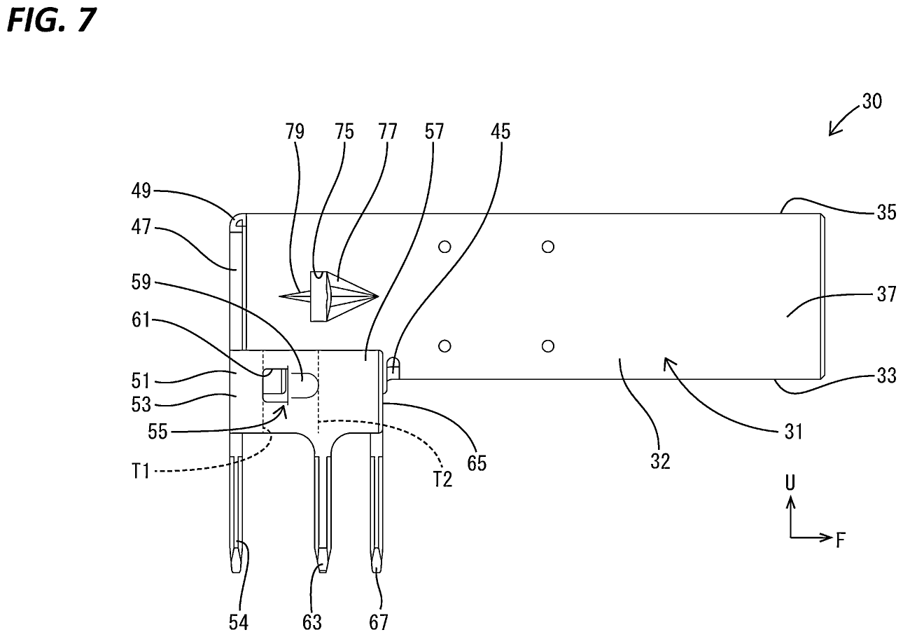

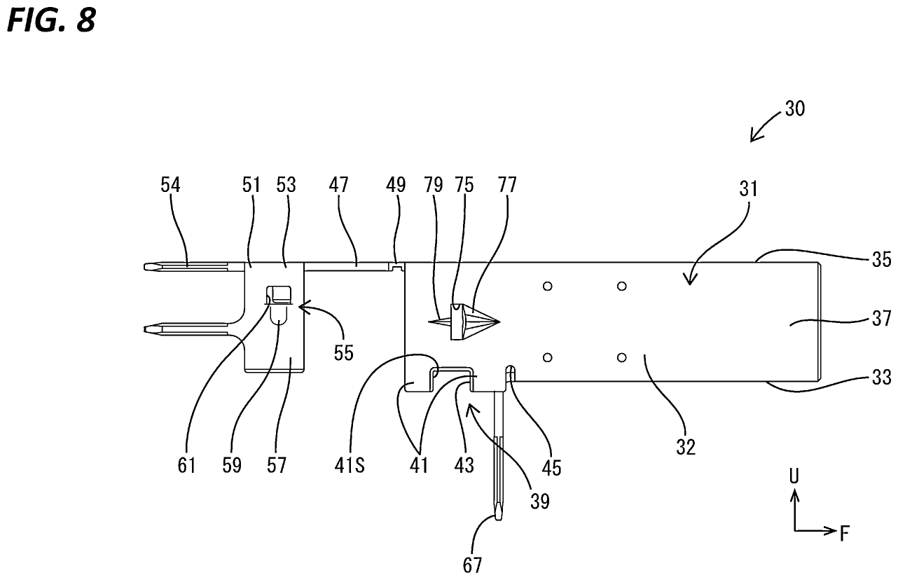

The outer conductor 30 is formed, for example, by bending an electrically conductive metal plate. As shown in FIGS. 7 and 8, the outer conductor 30 includes a body portion 31 in the form of a rectangular tube extending in the front-rear direction. The front and rear surfaces of the body portion 31 are respectively open forward and rearward. The body portion 31 is formed by a bottom portion 33 forming a lower side of the rectangular tube, a ceiling portion 35 forming an upper side, a pair of side portions 37 forming both lateral sides, and a pair of inner plate portions 39 extending downward from both side surfaces on rear end sides of the pair of side portions 37. The inner plate portion 39 has a thickness in the lateral direction and has a plate shape. The inner plate portion 39 includes a pair of lock receiving portions 41 projecting downward in both front and rear end parts. A space portion 43 in the form of a rectangular recess when viewed laterally is formed between the pair of lock receiving portions 41. The body portion 31 includes a tubular connecting portion 32 in front of the inner plate portions 39. Slits 45 extending in the vertical direction are formed between the front lock receiving portions 41 of the inner plate portions 39 and the tubular connecting portion 32. The tubular connecting portion 32 is easily bent into a rectangular tube shape by providing the slits between the flat plate-like inner plate portions 39 and the tubular connecting portion 32. A pair of the slits 45 are formed in both left and right end parts of a rear end part of the tubular connecting portion 32.

The outer conductor 30 includes a back plate portion 47 displaceable with respect to the body portion 31 from an open state (see FIG. 8) for opening an opening in the rear surface of the body portion 31 to a closed state (see FIG. 7) for closing the opening in the rear surface of the body portion 31. Further, the outer conductor 30 includes a flexible bending portion 49 connecting the back plate portion 47 and the ceiling portion 35 as shown in FIG. 8. The bending portion 49 is formed along the lateral direction between the back plate portion 47 and the ceiling portion 35.

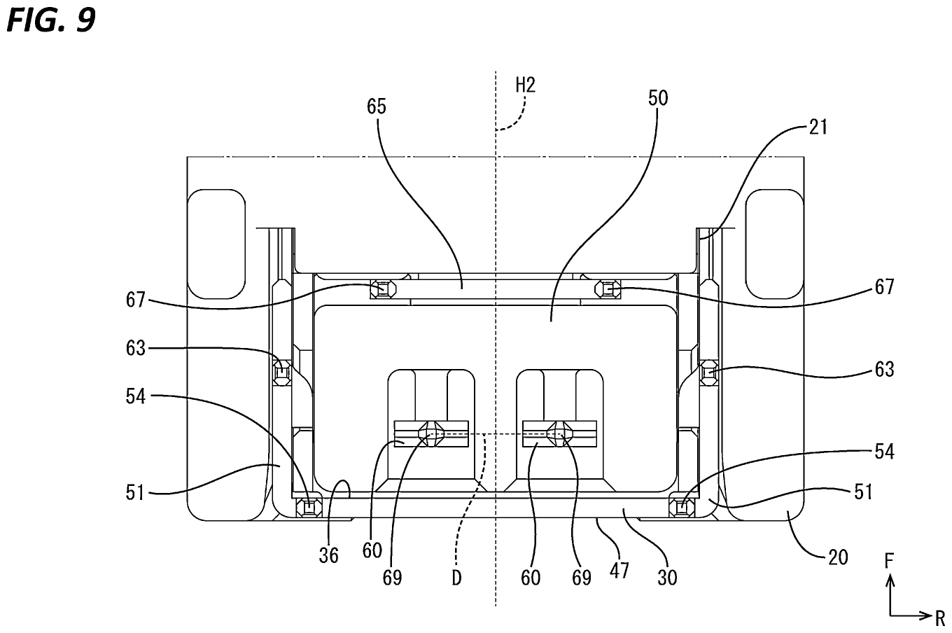

For example, if the bending portion 49 linearly extends in the front-rear direction, the back plate portion 47 can be horizontally arranged in the open state. Further, if the bending portion 49 is bent in a curved manner, the back plate portion 47 can be perpendicularly arranged in the closed state. In this way, the back plate portion 47 is rotatable with respect to the body portion 31 between the open state and the closed state via the bending portion 49. As shown in FIGS. 8 and 9, in the outer conductor 30, an opening 36 having a rectangular shape in a bottom view is formed by the back plate portion 47, the respective inner plate portions 39 and the bottom portion 33 in the closed state of the back plate portion 47. The dielectric 50 is pulled out downward (side where a circuit board 90 to be described later is located) through the opening 36.

The outer conductor 30 includes a pair of side plate portions 51 respectively projecting from both left and right end parts of the back plate portion 47. The pair of side plate portions 51 are plate-like and arranged with plate surfaces facing in the lateral direction. The respective side plate portions 51 project downward from the both left and right end parts of the back plate portion 47 in the open state. The respective side plate portions 51 project forward from the both left and right end parts of the back plate portion 47 in the closed state. The back plate portion 47 includes a pair of rear ground pins 54 extending downward from both left and right end parts of the lower end edge of a body part in the closed state. Each rear ground pin 54 is soldered and fixed to a through-hole formed in the circuit board 90.

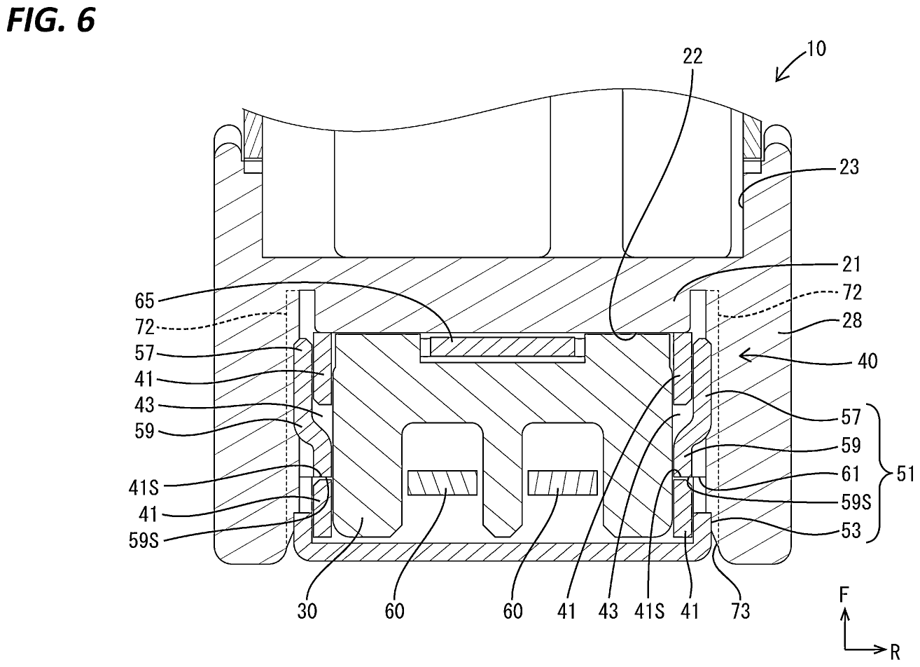

The side plate portion 51 includes a base end portion 53, a locking portion 55 and a tip portion 57. As shown in FIG. 7, the locking portion 55 includes a locking body portion 59 and a cut portion 61. The locking body portion 59 forms a front end side of the locking portion 55. As shown in FIG. 6, the locking body portion 59 is formed to be curved inward toward a rear side when viewed from above. As shown in FIG. 7, the outer edge of the locking body portion 59 has a semicircular shape by curving a front side when viewed laterally. The outer edge of the cut portion 61 has a rectangular shape extending in the vertical direction when viewed laterally and forms a rear end side of the locking portion 55. The cut portion 61 penetrates through the side plate portion 51. As shown in FIG. 6, the locking body portion 59 is arranged in the space portion 43 of the inner plate portion 39 in the closed state. The locking body portion 59 is accommodated in the space portion 43 by the contact of a rear end surface 59S of the locking body portion 59 and a front end surface 41S of the lock receiving portion 41 arranged on a rear side, out of the pair of lock receiving portions 41. The back plate portion 47 can be held in the closed state with respect to the body portion 31 by locking the side plate portions 51 and the inner plate portions 39. In the closed state of the back plate portion 47, the side plate portion 51 covers from the rear end of the inner plate portion 39 to the rear end of the slit 45 from outside. That is, the side plate portion 51 is arranged to be accommodated in a formation range of the inner plate portion 39 in the front-rear direction.

As shown in FIG. 7, the base end portion 53 is a part to be arranged further on the rear end side (side of the back plate portion 47) than the locking portion 55. Specifically, the base end portion 53 is a part of the side plate portion 51 between the rear end edge of the side plate portion 51, the rear end edge of the cut portion 61 and an extension line T of the rear end edge. The tip portion 57 is a part to be arranged further on the front end side than the locking portion 55. Specifically, the tip portion 57 is a part of the side plate portion 51 between a tangent line T2 to the front end of the locking body portion 59 and the front end edge of the side plate portion 51.

As described above, the base end portion 53, the locking portion 55 and the tip portion 57 are configured by dividing the body part of the side plate portion 51 rectangular in a side view into three in the front-rear direction. The side plate portion 51 includes a side ground pin 63 extending downward from a central part in the front-rear direction of the lower end edge of the body part. The side ground pin 63 is soldered and fixed to a through-hole formed in the circuit board 90.

As shown in FIG. 7, the outer conductor 30 includes a front plate portion 65 bent downward from the rear edge of the bottom portion 33. The front plate portion 65 is in the form of a rectangular plate when viewed from front. As shown in FIG. 9, the front plate portion 65 includes a pair of front ground pins 67 extending downward from both left and right end parts of a lower end edge. The pair of front ground pins 67 are soldered and fixed to through-holes formed in the circuit board 90. The front ground pins 67 are bilaterally symmetrically arranged with respect to the front plate portion 65. In the present disclosure, the ground pins indicate the front ground pins 67, the rear ground pins 54 and the pair of side ground pins 63. The respective ground pins (54, 63, 67) are electrically connected to electrically conductive portions for ground of the circuit board 90. The respective ground pins (54, 63, 67) are arranged around the inner conductors 60 when the outer conductor 30 is viewed from below. The respective ground pins (54, 63, 67) are bilaterally symmetrically arranged with respect to a line segment H2 extending in the front-rear direction through a center of an interval D between centers of the two inner conductors 60.

The inner conductor 60 is formed, such as by bending an electrically conductive metal plate. As shown in FIG. 2, the inner conductor 60 is L-shaped as a whole and includes a mating connecting portion 62 extending in the front-rear direction and a board connecting portion 69 extending in the vertical direction. The mating connecting portion 62 is electrically connected to a mating terminal fitting (not shown) provided in the mating connector by connecting the connector 10 and the mating connector. The board connecting portion 69 is soldered and fixed to a through-hole formed in the circuit board 90. The board connecting portion 69 is electrically connected to an electrically conductive portion for signal of the circuit board 90.

The dielectric 50 is made of an insulating synthetic resin material and includes, as shown in FIG. 2, terminal accommodation chambers 52 penetrating in the front-rear direction inside. The inner conductor 60 is press-fit into the terminal accommodation chamber 52. The inner conductor 60 is held in the dielectric 50 with the mating connecting portion 62 projecting forward through a front end opening of the terminal accommodation chamber 52. The inner conductor 60 and the outer conductor 30 are kept insulated by the dielectric 50.

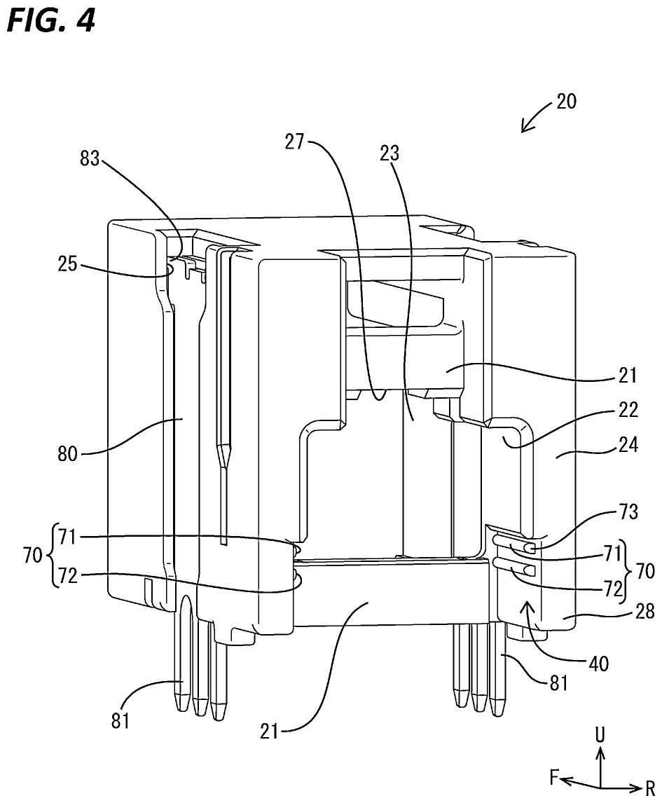

The housing 20 is made of synthetic resin and includes, as shown in FIGS. 2 and 4, a base wall portion 21 arranged with wall surfaces facing in the front-rear direction, a receptacle 23 in the form of a rectangular tube projecting forward from the outer peripheral edge of the base wall portion 21 and a pair of side wall portions 24 projecting rearward from both left and right end parts of the base wall portion 21. The pair of side wall portions 24 include a pair of wall portions 28 in lower end parts formed to be thinner than upper end parts.

As shown in FIG. 2, the receptacle 23 includes a housing lock portion 26 on the inner surface of an upper wall. The mating connector is fit into the receptacle 23. The housing lock portion 26 functions to lock the mating connector in the receptacle 23 by an unillustrated lock arm and hold the both connectors in a connected state.

As shown in FIGS. 1 and 2, the base wall portion 21 includes a mounting hole 27 penetrating in the front-rear direction (wall thickness direction of the base wall portion 21). A part of the body portion 31 of the outer conductor 30 is inserted and held in the mounting hole 27 of the base wall portion 21. A front part of the tubular connecting portion 32 projects into the receptacle 23. The housing 20 includes an accommodation space 22 open rearward behind the base wall portion 21 and between the respective side wall portions 24. Out of the outer conductor 30, a part (hereinafter, referred to as a “rear part of the outer conductor 30”) projecting rearward from the mounting hole 27 is arranged in the accommodation space 22 and has both left and right sides covered and protected by the side wall portions 24. With the outer conductor 30 accommodated in the housing 20, the front end surfaces of the inner plate portions 39 are arranged to be able to contact the rear surface of the base wall portion 21 and specify the position of the outer conductor 30 in a forward direction.

The inner surface of each wall portion 28 is facing the accommodation space 22. The inner surface of each wall portion 28 is a vertical surface along the front-rear direction and vertical direction. With the rear part of the outer conductor 30 arranged in the accommodation space 22, the inner surface of each wall portion 28 is arranged to face the outer surface of each side plate portion 51 of the outer conductor 30. The outer surface of each side plate portion 51 is covered by each wall portion 28. Each side plate portion 51 can be pressed toward an inner side where the inner plate portion 39 is located by a pressing portion 40 provided on each wall portion 28.

The pressing portion 40 is formed by each wall portion 28 and a plurality of pressing body portions 70 projecting from the inner surface of each wall portion 28. Each pressing body portion 70 is in the form of a rib extending in the front-rear direction. Each pressing body portion 70 has a curved cross-sectional shape. A curved top part of each pressing body portion 70 contacts the outer surface of each side plate portion 51. A part where each pressing body portion 70 contacts the outer surface of each side plate portion 51 serves as a pressing part of the pressing portion 40 for each side plate portion 51.

The front end of each pressing body portion 70 is integrally coupled to the rear surface of the base wall portion 21. The rear end of each pressing body portion 70 is arranged in front of the rear end of each wall portion 28. The rear end of each pressing body portion 70 is formed into a tapered portion 73, which is a surface tapered and inclined inward toward a front side. The respective side plate portions 51 move along the tapered portions 73 of the respective pressing body portions 70 and are smoothly accommodated into the accommodation space 22 between the respective wall portions 28 in an assembly process of the outer conductor 30.

A pair of the pressing body portions 70 are arranged in the vertical direction on each wall portion 28. The pressing body portions 70 paired in the vertical direction are arranged at height positions corresponding to the locking portion 55 of the side plate portion 51. Out of the pressing body portions 70 paired in the vertical direction, the pressing body portion arranged on an upper side is configured as an upper rib 71 capable of contacting an upper end part of the outer surface of the side plate portion 51. Out of the pressing body portions 70 paired in the vertical direction, the pressing body portion arranged on a lower side is configured as a lower rib 72 capable of contacting a middle part in the vertical direction of the outer surface of the side plate portion 51.

As shown in FIG. 8, a rear end part of the body portion 31 includes a pair of body-side locking holes 75 (only one is shown) open in the lateral direction and having a rectangular shape long in the vertical direction in central parts in the vertical direction of the pair of side portions 37. The body-side locking holes 75 are arranged behind the slits 45. The body portion 31 includes a pair of outer locking portions 77 on front sides of the respective body-side locking holes 75. The body portion 31 includes a pair of inner locking portions 79 on rear sides of the respective body-side locking holes 75. The outer locking portion 77 is formed by bending and raising the side portion 37 of the body portion 31 outward in the lateral direction via the body-side locking hole 75, and formed into a claw shape substantially triangular in a side view. By locking the respective outer locking portions 77 to the base wall portion 21, the outer conductor 30 passed thorough the mounting hole 27 is held and fixed in the housing 20. Each inner locking portion 79 is formed by bending and raising the side portion 37 of the body portion 31 inward in the lateral direction via the body-side locking hole 75, and formed into a claw shape substantially triangular in a side view. The inner locking portion 79 is one size smaller than the outer locking portion 77. By locking the both inner locking portions 79 to the dielectric 50, the dielectric 50 is held and fixed in the body portion 31.

As shown in FIG. 4, a pair of fixing brackets 80 are press-fit in outer surfaces on both left and right sides of the receptacle 23. The fixing bracket 80 includes press-fit projections 83 projecting in the front-rear direction in an upper end part. The press-fit projections 83 are inserted and locked in press-fit recesses 25 of the housing 20. The fixing bracket 80 includes a board connection pin 81 extending downward in a lower end part. The board connection pin 81 is soldered and fixed to a fixing hole formed in the circuit board 90.

### [Functions and Effects of Connector 10]

Next, an example of an assembly procedure of the connector 10 of this embodiment is described.

When the back plate portion 47 is in the open state, the dielectric 50 having the inner conductors 60 inserted therein is inserted into the outer conductor 30. Subsequently, the back plate portion 47 is rotated and displaced from the open state to the closed state via the bending portion 49. In the process of displacing the back plate portion 47 to the closed state, the locking body portions 59 of the locking portions 55 in the pair of side portions 37 interfere with the corresponding lock receiving portions 41 and the pair of side plate portions 51 are expanded and deformed (resiliently deformed) outward with coupled parts to the back plate portion 47 as fulcrums.

When the back plate portion 47 reaches the closed state, the opening in the rear surface of the body portion 31 is closed by the back plate portion 47 and the pair of resiliently restored side plate portions 51 cover the entire lock receiving portions 41 of the corresponding inner plate portions 39 from outside. The front end surfaces 41S of the lock receiving portions 41 arranged on the rear side and the rear end surfaces 59S of the locking body portions 59 are arranged to be able to face and contact each other. In this way, a return displacement of the back plate portion 47 to the open state is prevented and the box shape of the outer conductor 30 is maintained.

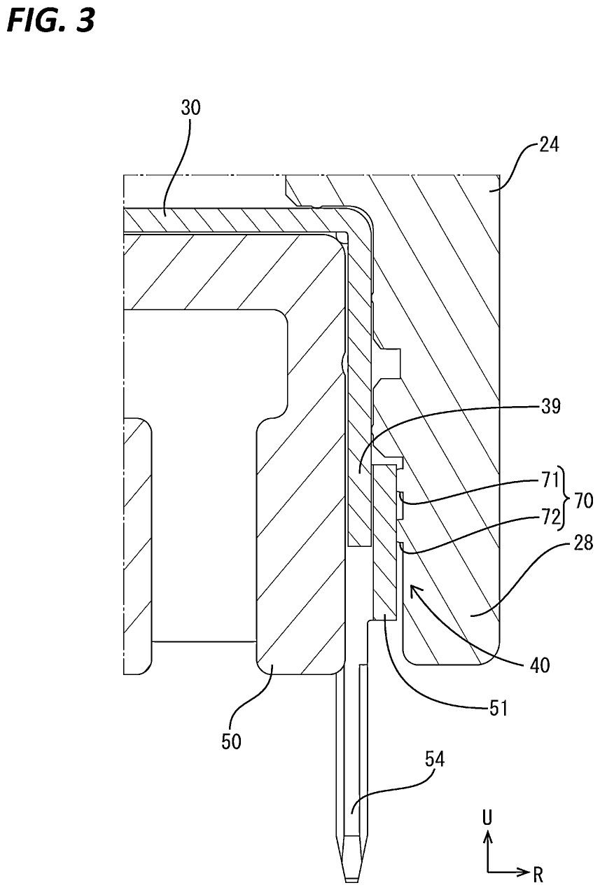

Subsequently, the body portion 31 of the outer conductor 30 is inserted and held into the mounting hole 27 of the base wall portion 21 of the housing 20 from behind. The rear part of the outer conductor 30 is accommodated into the accommodation space 22. The inner plate portions 39 and the side plate portions 51 are covered by the respective wall portions 28 of the housing 20. As shown in FIG. 3, the respective pressing body portions 70 of the pressing portions 40 come into contact with the outer surfaces of the side plate portions 51 of the outer conductor 30. In this way, an inward pressing force is applied to each side plate portion 51 and each side plate portion 51 is firmly pressed against the outer surface of each inner plate portion 39. In this way, the inner surface of each side plate portion 51 and the outer surface of each inner plate portion 39 come into surface or point contact with each other except locking parts of the locking portion 55 and the lock receiving portions 41.

In the case of this embodiment, the pressing parts of the pressing portion 40 for each side plate portion 51 are provided in an entire or nearly entire range in the front-rear direction of each side plate portion 51. Specifically, the pressing parts of the pressing portion 40 for each side plate portion 51 are provided in an upper end part and a vertically middle part of the tip portion 57 of each side plate portion 51 and in an upper end part and a vertically middle part of the base end portion 53 of each side plate portion 51. Further, each pressing body portion 70 is arranged to be able to partially contact the outer surface of the locking portion 55. Particularly, since the tip portion 57 of the side plate portion 51 is located distant from the coupled part of the side plate portion 51 and the back plate portion 47, the tip portion 57 is easily separated from the outer surface of the inner plate portion 39. A contact state of the side plate portion 51 and the inner plate portion 39 can be effectively maintained by the pressing body portions 70 pressing the tip portion 57 from a rear end to a front end. The maintaining of the contact state of the side plate portion 51 and the inner plate portion 39 is synonymous with the maintaining of an electrically connected state of the side plate portion 51 and the inner plate portion 39.

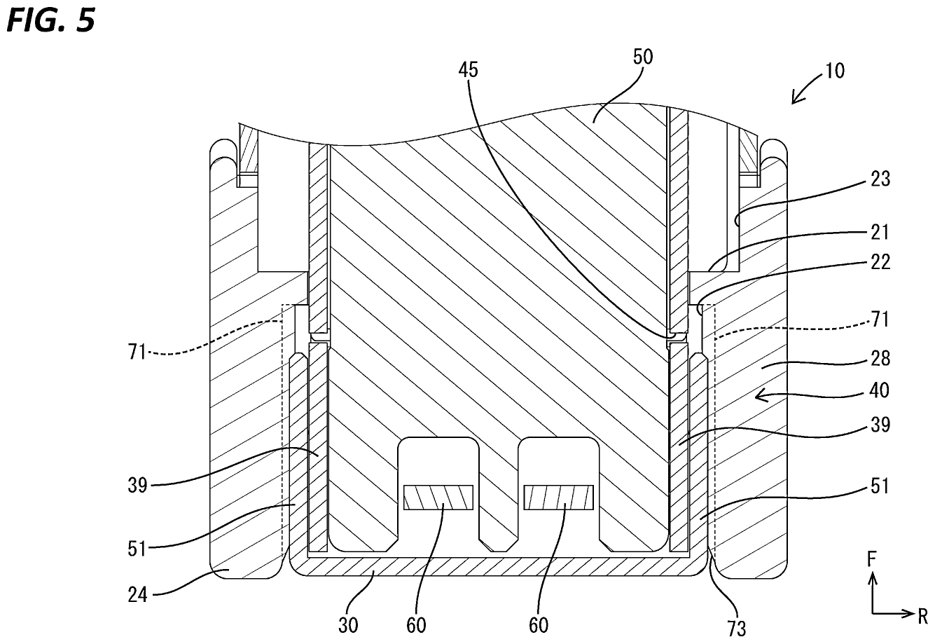

The side plate portions 51 of the outer conductor 30 are smoothly inserted into the accommodation space 22 of the housing 20 without rattling by the tapered portions 73 formed on the rear ends of the pressing body portions 70. Since the tapered portions 73 are formed only on the rear ends of the pressing body portions 70, the pressing of the tip portions 57 is not hindered. As shown in FIG. 3, the upper rib 71 presses an upper side of the side plate portion 51. As shown in FIG. 5, the upper rib 71 tightly presses the upper end part of the smooth side plate portion 51 from the rear end to the front end in the front-rear direction. The contact of the side plate portion 51 and the inner plate portion 39 is stably maintained by the upper rib 71.

As shown in FIG. 6, the lower rib 72 presses from the base end portion 53 to the tip portion 57 in the front-rear direction. Further, the lower rib 72 presses centers in the vertical direction of the locking body portion 59 and the cut portion 61 in the front-rear direction. The lower rib 72 projects inward from the inner surface of the wall portion 28. A part where the locking body portion 59 and the cut portion 61 are formed is a part where the side plate portion 51 and the inner plate portion 39 are locked. By pressing this part by the lower rib 72, the locking body portion 59 is reliably fixed in the space portion 43 of the inner plate portion 39. As shown in FIG. 7, the side plate portion 51 is in contact with the inner plate portion 39 in a range from the rear end edge of the inner plate portion 39 to the rear end edge of the slit 45. In this way, the bypass of a current flowing from the body portion 31 of the outer conductor 30 to each ground pin (54, 63, 67) can be prevented.

Both the upper and lower ribs 71, 72 press the tip portion 57 of the side plate portion 51. The tip portion 57 of the side plate portion 51 is a part particularly easily separated from the inner plate portion 39 due to vibration or the like. By pressing the tip portion 57 of the side plate portion 51, the separation of the side plate portion 51 from the inner plate portion 39 can be effectively prevented.

After the outer conductor 30 is inserted into the housing 20, the connector 10 is installed on a surface of the circuit board 90. Specifically, the board connection pins 81 of the fixing brackets 80 press-fit into the housing 20 are fixed to the fixing holes of the circuit board 90 by soldering. The board connecting portions 69 of the inner conductors 60 are conductively connected to the through-holes of the circuit board 90 by soldering. The tips of the respective ground pins (54, 63, 67) are conductively connected to a ground circuit formed on the surface of the circuit board. Here, the respective ground pins (54, 63, 67) are arranged around the board connecting portions 69. As shown in FIG. 9, the respective ground pins (54, 63, 67) are bilaterally symmetrically arranged with respect to the line segment H2 extending in the front-rear direction through the center in the width direction of the outer conductor 30. The line segment H2 passes through the center of the interval D between the board connecting portions 69. The inner conductors 60 and the respective ground pins (54, 63, 67) extend in parallel in the vertical direction toward the circuit board.

In the connector 10 of this embodiment, the outer sides of the inner plate portions 39 and the inner sides of the side plate portions 51 are tightly in contact in the front-rear direction by the pressing of the pressing body portions 70. In this way, a current path of a current flowing from the outer conductor to the respective ground pins (54, 63, 67) is not bypassed. By the non-bypassed current in the current path, electric field leakage of signal lines caused by the inner conductors 60 is prevented. Accordingly, the connector 10 enhances shielding performance for the signal lines conductive with the inner conductors 60 by the current flowing from the outer conductor to the respective ground pins (54, 63, 67). Further, the respective ground pins (54, 63, 67) are bilaterally symmetrically arranged with respect to the line segment H2. The electric field leakage of the signal lines conductive with the inner conductors 60 is effectively suppressed by the current flowing to the ground pins (54, 63, 67) and shielding performance for the signal lines is enhanced as compared to the case where the respective ground pins (54, 63, 67) are asymmetrically arranged with respect to the inner conductors 60.

The connector 10 of this embodiment is provided with the outer conductor 30, the housing 20 for accommodating the outer conductor 30 and the inner conductors 60 arranged inside the outer conductor 30. The outer conductor 30 includes the tubular body portion 31 having the open front and rear surfaces. The outer conductor 30 includes the back plate portion 47 coupled to the body portion 31 displaceably from the open state for opening the opening in the rear surface of the body portion 31 to the closed state for closing the opening in the rear surface of the body portion 31. The outer conductor 30 includes the side plate portions 51 projecting from the both left and right end parts of the back plate portion 47. The body portion 31 includes the inner plate portions 39 arranged in the both left and right end parts. The pair of inner plate portions 39 are arranged in contact with the inner surfaces in the lateral direction of the pair of side plate portions 51 in the closed state of the back plate portion 47. The housing 20 includes the pressing portions 40 for pressing the side plate portions 51 against the inner plate portions 39. According to this configuration, since the side plate portions 51 are pressed against the inner plate portions 39 by the pressing portions 40 of the housing 20, the connected state of the side plate portions 51 and the inner plate portions 39 can be maintained and the shielding performance of the outer conductor 30 can be stabilized.

In the connector 10 of this embodiment, the pressing portion 40 includes the wall portion 28 for covering the outer surface in the lateral direction of the side plate portion 51 and the pressing body portions 70 projecting from the wall portion 28 and to be held in contact with the outer surface of the side plate portion 51. By adjusting the formation positions and the formation ranges of the pressing body portions 70 on the wall portion 28, the connected state of the side plate portion 51 and the inner plate portion 39 can be properly maintained.

In the connector 10 of this embodiment, the side plate portion 51 includes the locking portion 55 for locking the inner plate portion 39. The side plate portion 51 is formed with the base end portion 53, the locking portion 55 and the tip portion 57 successively arranged from the side of the back plate portion 47 to a tip in a projecting direction. The locking portion 55 locks the inner plate portion 39. In this connector 10, the pair of pressing body portions 70 are configured to contact at least the outer surface of the side plate portion 51. According to this configuration, if the side plate portion 51 is opened laterally outward with a part coupled to the back plate portion 47 on the side of the base end portion 53 as a fulcrum, the tip portion 57 is displaced more laterally outward than the base end portion 53. In contrast, this configuration can suppress a lateral outward displacement of the tip portion 57 since the pressing body portions 70 contact the outer surface of the tip portion 57. As a result, the side plate portion 51 can be effectively prevented from being opened laterally outward, and the connected state of the side plate portion 51 and the inner plate portion 39 can be more properly maintained.

In the connector 10 of this embodiment, the pressing body portions 70 are arranged apart in the vertical direction on the wall portion 28. According to this configuration, since the respective pressing body portions 70 can press the side plate portion 51 at different positions spaced apart in the vertical direction, a displacement of either one of end parts in the vertical direction of the side plate portion 51 in a direction separating from the inner plate portion 39 can be suppressed.

In the connector 10 of this embodiment, the pressing body portion 70 is in the form of a rib extending in the front-rear direction across the locking portion 55 and configured to contact the outer surface of the base end portion 53 and the outer surface of the tip portion 57. According to this configuration, lateral outward displacements of the tip portion 57 and the base end portion 53 can be suppressed.

In the connector 10 of this embodiment, preferably, the body portion 31 includes the tubular connecting portion 32 arranged in front of the inner plate portions 39 and the slits 45 formed between the tubular connecting portion 32 and the inner plate portions 39, and the side plate portions 51 are arranged to be accommodated within the formation range in the front-rear direction of the inner plate portions 39. According to this configuration, since a state where the inner surfaces of the side plate portions 51 are in contact with only the inner plate portions 39 can be realized, the connected state of the side plate portions 51 and the inner plate portions 39 can be more properly maintained.

In the connector 10 of this embodiment, the side plate portion 51 includes the side ground pin 63 to be connected to the circuit board 90. According to this configuration, since a ground current can flow from the side plate portion 51 to the circuit board 90, shielding performance can be improved as compared to the case where the side plate portion 51 includes no side ground pin 63.

### Other Embodiments of Present Disclosure

The present disclosure is not limited to the above described and illustrated embodiment, but is represented by claims. The present disclosure includes all changes in the scope of claims and in the meaning and scope of equivalents and also includes the following embodiments.

(1) The connector of the above embodiment includes a total of six ground pins (54, 63, 67). The number of ground pins is not limited as long as the ground pins are symmetrical with respect to a center line extending in the front-rear direction through a center between inner conductors.

(2) The ground pins (54, 63, 67) and the board connecting portions 69 of the connector 10 of the above embodiment are passed through the through-holes formed in the circuit board 90. End parts of the respective ground pins and the board connecting portions may be surface-mounted.

(3) Although the body portion 31 of the connector 10 of the above embodiment has a rectangular tube shape, the body portion 31 may have a round tube shape.

(4) Although the back plate portion 47 of the outer conductor 30 of the above embodiment is connected to the body portion 31, a back plate portion may be another member removable from an outer conductor.

(5) Although the pair of fixing brackets 80 are press-fit into the outer surfaces on the both left and right sides of the receptacle 23 of the housing 20 of the above embodiment, the shape of a housing is not limited and may be, for example, configured not to use fixing brackets.

(6) Although the inner conductors 60 and the respective ground pins (54, 63, 67) of the above embodiment extend in parallel toward the circuit board 90, inner conductors and ground pins need not be parallel if extending side by side in the same direction. For example, ground pins may be configured to extend not perpendicularly, but obliquely toward a circuit board.

(7) The locking portion 55 of the above embodiment is formed by the locking body portion 59 having the front side curved into a semicircular shape when viewed laterally and the cut portion 61 having the substantially rectangular outer edge when viewed laterally. The shape of a locking portion is not limited. For example, a locking body portion may have a substantially rectangular shape, and a cut portion may not be provided. Further, the locking portion may have a known locking configuration.

(8) Although the pressing body portions 70 are provided to project from the inner surface of the wall portion 28 of the above embodiment, the pressing body portions need not necessarily be provided. For example, the inner surface of a wall portion may be configured to directly press a side plate portion.

(9) Although the lower rib 72 of the above embodiment covers a part of the locking portion 55, a lower rib may not necessarily be in contact with a locking portion.

(10) Although the slit 45 of the above embodiment is formed by cutting the side portion 37 inward into a semicircular shape, the shape of a slit is not limited to this. For example, a slit may be shaped by acutely cutting a side plate inward.

(11) Although the pressing body portions 70 of the above embodiment include the upper rib 71 for pressing the upper end part of the side plate portion 51 and the lower rib 72 for pressing the locking portion 55 of the side plate portion 51, a pressing body portion for pressing a side plate portion at a position separated downward from a locking portion may be separately provided.

(12) Although the pressing body portion 70 of the above embodiment has an arcuate shape bulging inward when viewed from behind and extends from the front end to the rear end on the inner wall surface of the wall portion 28, pressing body portions may be scattered in the front-rear direction on an inner wall surface. Further, a pressing body portion may have a rectangular column shape projecting inward when viewed from behind. A pressing body portion may not have a rib shape, but have, for example, a projecting boss shape.

(13) Although the wall portions 28 of the above embodiment are formed in parallel to extend perpendicularly in the vertical direction with respect to the lateral direction of the housing 20, wall portions need not be formed in parallel to extend perpendicularly in a vertical direction with respect to a lateral direction of a housing. For example, the wall portions may be inclined to narrow a facing interval between the wall portions in an upward direction.

(14) The pressing body portions 70 of the above embodiment are configured to contact the outer surface of each of the tip portion 57 and the base end portion 53. A pressing body portion may be configured to contact only the outer surface of a tip portion.

(15) The curved top part of the pressing body portion 70 of the above embodiment is deformed to be flat by contacting the outer surface of each side plate portion 51 when viewed from behind in an inserted state of the side plate portion 51 in the housing 20. A curved top part of a pressing body portion may be arbitrarily deformed. Further, a side plate portion may be deformed in a state inserted in a housing.

(16) The pressing body portions 70 of the above embodiment are arranged in a pair on the wall portion 28 while being spaced apart in the vertical direction. The number of the pressing body portions 70 is not limited and one pressing body portion may be provided on one wall portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
an outer conductor;
a housing for accommodating the outer conductor; and
an inner conductor to be arranged inside the outer conductor,
the outer conductor including:
a tubular body portion having open front and rear surfaces;
a back plate portion arranged displaceably with respect to the body portion from an open state for opening an opening in the rear surface of the body portion to a closed state for closing the opening in the rear surface of the body portion; and
side plate portions projecting from left and right end parts of the back plate portion,
the body portion including inner plate portions arranged in the left and right end parts,
the inner plate portions being arranged to contact inner surfaces in a lateral direction of the side plate portions in the closed state of the back plate portion, and
the housing including pressing portions for pressing the side plate portions against the inner plate portions.

2. The connector of claim 1, wherein the pressing portion includes:
a wall portion for covering an outer surface in the lateral direction of the side plate portion; and
a pressing body portion for contacting the outer surface of the side plate portion by projecting from the wall portion.

3. The connector of claim 2, wherein:
the side plate portion is formed with a base end portion, a locking portion and a tip portion successively arranged from the back plate portion side to a tip in a projecting direction,
the locking portion includes the inner plate portion, and
the pressing body portion is configured to contact at least the outer surface of the tip portion.

4. The connector of claim 3, wherein the pressing body portion is in the form of a rib extending in a front-rear direction across the locking portion and configured to contact the outer surface of the base end portion and the outer surface of the tip portion.

5. The connector of claim 1, wherein:
the body portion includes:
a tubular connecting portion to be arranged in front of the inner plate portions; and
a slit formed between the tubular connecting portion and the inner plate portion, and
the side plate portion is arranged to be accommodated in a formation range in a front-rear direction of the inner plate portion.

6. The connector of claim 1, wherein the side plate portion includes a side ground pin to be connected to a circuit board.
